(19) United States
(12) Patent Application Publication
(10) Pub. No.: US 2008/0303633 A1
(43) Pub. Date: Dec. 11, 2008

(54) HIGH GAIN RFID TAG ANTENNAS

(75) Inventors: Chi Ho Cheng, Hong Kong (CN); Ross David Murch, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/129,953

(22) Filed: May 30, 2008

Related U.S. Application Data
(60) Provisional application No. 60/942,596, filed on Jun. 7, 2007.

(51) Int. Cl. H04Q 5/22

(52) U.S. Cl. 340/10.1

(57) ABSTRACT

A non-pervasive modification to radio frequency identification (RFID) tag antennas is provided that can double the tag's reading range distance. Parasitic elements, such as a reflector and one or more directors, are added at appropriate separations to form a Yagi antenna. As a result, the antenna's gain is increased and consequently so is the RFID tag's reading range. The tag antenna's gain can be achieved without directly connecting to or modifying the existing RFID tag. However, since directionality is increased, multiple RFID tags can be attached to an object so that the tagged object can be read from multiple directions.

### CROSS REFERENCE TO RELATED APPLICATIONS

This non-provisional application claims benefit under 35 U.S.C. § 119(e) of U.S. provisional Application No. 60/942,596, filed Jun. 7, 2007, which is hereby incorporated by reference.

### TECHNICAL FIELD

The subject disclosure relates generally to improving the gain of radio frequency identification tags, such as passive ultra high frequency radio frequency identification tags.

### BACKGROUND

Recently, radio frequency identification (RFID) systems have become popular for commercial use. Applications include for example intelligent transportation systems (e.g., automobile theft prevention, automated parking, high speed toll collection, traffic management), commerce (e.g., factory automation, inventory management and tracking, merchandise theft prevention, tracking and library book theft prevention, parcel and document tracking, livestock tracking, dispensing goods, controlled ski lift access, fare collection), and security (e.g., access control to buildings and facilities, controlled access to gated communities, corporate campuses, and airports; U.S. Homeland Security applications such as secure border crossing and container shipments with expedited low-risk activities; people or pet tracking).

A typical RFID system comprises for example a simple device on one end of the communication path (e.g., tags or transponders) communicatively coupled to a more complex device (e.g., readers, interrogators, beacons). RFID tags are typically small and inexpensive so that they can be economically deployed on a large scale and attached to the tracked/tagged objects. RFID tags should also operate well in diverse environments. The RFID readers are typically more capable electronic devices and are usually connected to a host computer or host network by either wired or wireless connection. RFID systems can be read-only (data transfer from RFID tag to reader only) or read-write (data can be written to an RFID tag memory e.g., EEPROM).

Conventionally, RFID tags typically comprise two components: a single custom CMOS circuit (e.g., an application specific integrated circuit or ASIC), although other technologies have been used (e.g., surface acoustic wave devices or tuned resonators), and an antenna. Tags can be powered by a battery or other physically connected power source (e.g., in active RFID), by rectification of the radio signal sent by the reader (e.g., in passive RFID), or a combination of the two (e.g., semi-passive RFID). RFID tags typically send data to the reader by changing the loading of the tag antenna in a coded manner or by generating, modulating, and transmitting a radio signal.

Passive RFID tags typically comprise an integrated circuit mounted on a strap that contains an antenna layout. Passive tags, which can operate at 125 kHz or 13 MHz, have been developed for many years. Traditionally, passive transponders operating at 125 kHz or 13 MHz used coils as antennas. These transponders operate in the magnetic field of the reader's antenna, and their reading distance is typically limited to less than about 1.2 meters. These systems suffer from low efficiency of more reasonably sized antennas at such low frequencies. Due to the demand for higher data rates, longer reading distances, and small antenna sizes, there is a strong interest in UHF frequency band RFID transponders, especially for the 868/915 MHz and 2.4 GHz Industrial, Scientific and Medical (ISM) bands.

As the demand for longer reading distances has spurred the development of RFID tags that work in 915 MHz and 2.4 GHz ISM bands, this necessitated further development of appropriate antenna designs. Several factors influence the reading range distance of the passive tag. This includes the transmitter effective isotropic radiated power (EIRP), minimum threshold power to power up the tag, the matching between the antenna and tag and also the tag antenna's gain. The maximum allowed value for transmitter EIRP is determined by local country regulations while the minimum power up threshold is limited by the state-of-the-art integrated circuit design technology. Therefore, better matching and higher antenna gain can be an effective way to improve the tag reading range.

The above-described deficiencies of RFID tag antennas are merely intended to provide an overview of some of the problems of today's antennas, and are not intended to be exhaustive. Other problems with the state of the art may become further apparent upon review of the description of various non-limiting embodiments of the invention that follows.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

According to one aspect, a tagged object is provided that has an RFID tag and one or more parasitic elements, such as reflectors and directors. The parasitic elements are positioned in close proximity to the RFID antenna (e.g., within 100 millimeters) and essentially, or for the most part, parallel to the longitudinal axis of the RFID tag's antenna. For example, in one embodiment, two directors and a reflector are positioned with the reflector on the opposite side of the tag antenna from the two directors. Various RFID antenna designs can used, such as the I-type antenna or the squiggle antenna. The parasitic elements can be added without directly modifying or connecting to the RFID tag's antenna. In some embodiments, the tagged object has multiple RFID tags to counter the directionality effect of the parasitic elements. The tagged object can include, but is not limited to, product packaging, access fobs and cards (e.g. employee ID cards, parking pass, building access cards), machine consumables (ink cartridges, toner cartridges), surgical instruments, paper-based files, machine parts, animals, and electronic financial transaction cards and fobs (e.g., debit cards, transit passes, tolls).

According to another aspect, a method of improving the reading distance of a passive RFID tag is provided. The method involves attaching an RFID tag to a surface and subsequently adding parasitic elements substantially parallel to the longitudinal axis of the RFID tag's antenna. Advantageously, the addition of the parasitic elements can occur without direct modifications to the RFID tag. Thus, commercially-available tags without parasitic elements can have the parasitic elements added after manufacture of a tag or after attachment of a tag to an object. In other embodiments, the parasitic elements can be added during tag manufacture.

According to yet another aspect, an RFID system is provided that has multiple RFID tags with parasitic elements and an RFID reader to communicate with those tags.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is an exemplary non-limiting block diagram generally illustrating an operating environment suitable for implementation of the present invention.

FIG. 2 is a block diagram depiction of an RFID tag.

FIGS. 3A and 3B illustrate various designs of RFID tags that can be supplemented with parasitic elements.

FIGS. 4A and 4B illustrate an RFID tag with parasitic elements added according to one embodiment.

FIGS. 5A-5B are graphs of the real part and imaginary part of impendance curves versus frequency for an RFID tag with parasitic elements and for an unmodified RFID tag.

FIG. 6 is a graph illustrating the simulated return loss of an RFID tag with and without parasitic elements.

FIGS. 7A-7B are graphs illustrating the simulated pattern of an RFID tag with parasitic elements.

FIG. 8 illustrates an example block diagram of an experiment to determine the increased reading range of RFID tags with parasitic elements.

FIG. 9 is an example flow diagram of a method of improving the gain of an RFID antenna.

### DETAILED DESCRIPTION

The present invention is now described with reference to the drawings, wherein like reference numerals are used to refer to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In various non-limiting embodiments, some dimensions are given for positioning a reflector and/or a director with respect to an axis of an antenna. For instance, in one embodiment, a reflector is positioned between about 50 millimeters and about 100 millimeters from the antenna axis and one or more directors are positioned between about 40 millimeters and about 100 millimeters from the antenna axis. However, for the avoidance of doubt, these dimensions should be considered as non-limiting examples. In this regard, it is to be understood that such dimensions depend on the wavelength of the RFID radiation. For instance, where the frequency is around 900 MHz, the corresponding wavelength is about 300 millimeters. Therefore, such dimensions can be set between about ⅙ and ⅓ of a wavelength. Thus, in the particular example of 900 MHz, the dimensions are around 50-100 millimeters.

900 MHz is used as a representative, but non-limiting frequency herein because 900 MHz is the approximate frequency at which many VHF tags operate. Accordingly, various results and dimensions given herein are for frequencies around 900 MHz, however, again such examples should be considered non-limiting. For frequencies f (in MHz) other than 900 MHz, the dimensions can be scaled, or multiplied, by 900/f to achieve a similar effect as described herein.

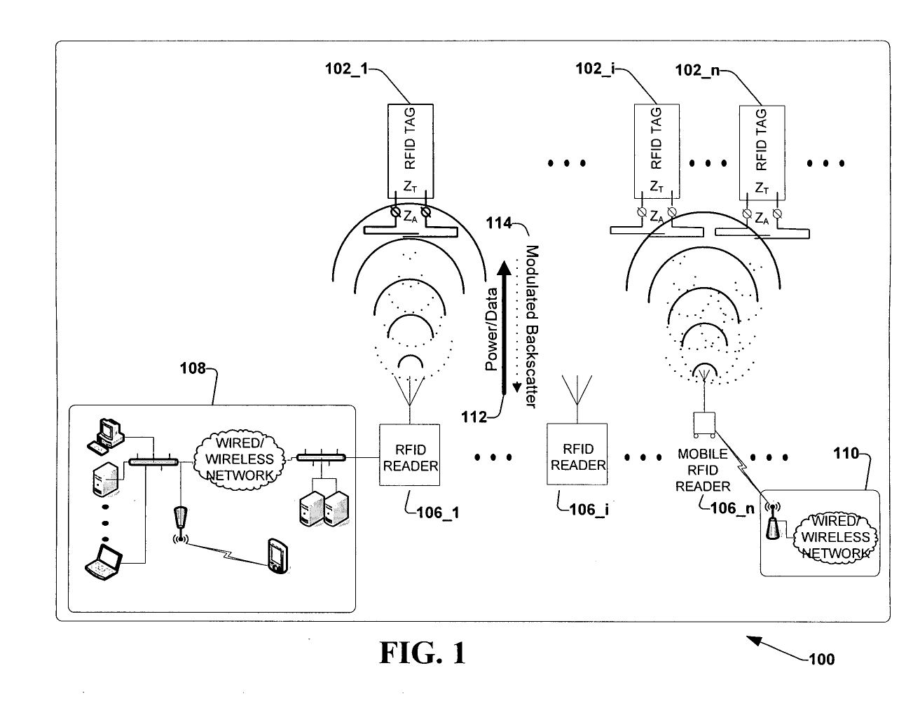

Referring now to FIG. 1, FIG. 1 is an exemplary non-limiting block diagram generally illustrating an operating environment suitable for implementation of the present invention. An operating RFID system typically comprises an RFID tag 102 in the presence of an RFID reader 106. The RFID reader 106 exposes the RFID tag (102) to EM radiation intended to activate the RFID tag (102), which then takes the desired action (e.g., returning an encoded data signal to the reader to accomplish inventory control, toll collection, etc.). Although the RFID reader 106 can be a standalone device, typically the reader is connected to external systems (e.g., 108, 110) to achieve the purposes as described above. For example, the data received by the reader may be transferred to systems 108 or 110 for the purposes of data storage and analysis, or to trigger a further action (e.g., debiting an account, reordering depleted inventory, triggering a downstream manufacturing step, etc.). Although for the present purposes, FIG. 1 shows a limited number of RFID readers 106 and RFID tags (102), a typical implementation is not so limited, as any number and combination of reader, tags, and external connections may exist according to the intended function of the system design.

As an example, a passive back-scattered RFID system 100 typically operates as follows. The RFID reader 106 transmits a modulated signal 112 (illustrated by the solid lines emanating from the RFID reader 106 antenna) with periods of unmodulated carrier, which is received by the RFID tag antenna. The RF voltage developed on antenna terminals during unmodulated period is converted to dc. This voltage powers up the ASIC of the RFID tag 102, which sends back the information stored in the RFID tag ASIC by varying its front end complex RF input impedance. The impedance typically toggles between two different states (e.g., between conjugate match and some other impedance) effectively modulating the back-scattered signal 114 (illustrated by the dotted lines emanating from the RFID tag antenna).

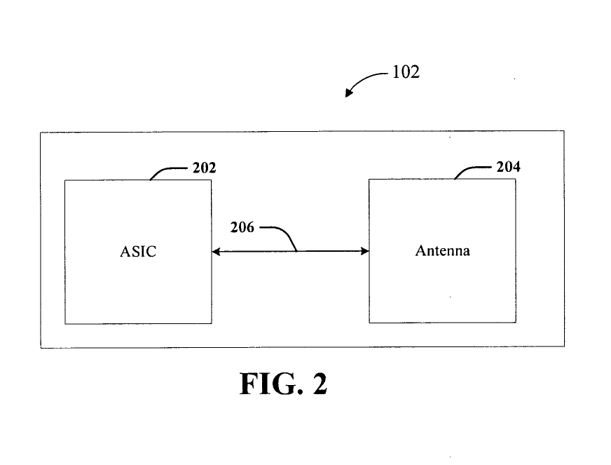

Referring to FIG. 2, a block diagram of an RFID tag 102 according to one embodiment is illustrated. The RFID tag includes an ASIC 202 that is in electrical communication with antenna 204. Other integrated circuits can be used in place of an ASIC. The ASIC is associated with a unique identifier—except in RFID applications that do not need a unique identifier for each object, such as foreign object detection. The electrical communication can be made via a conductive pathway 206.

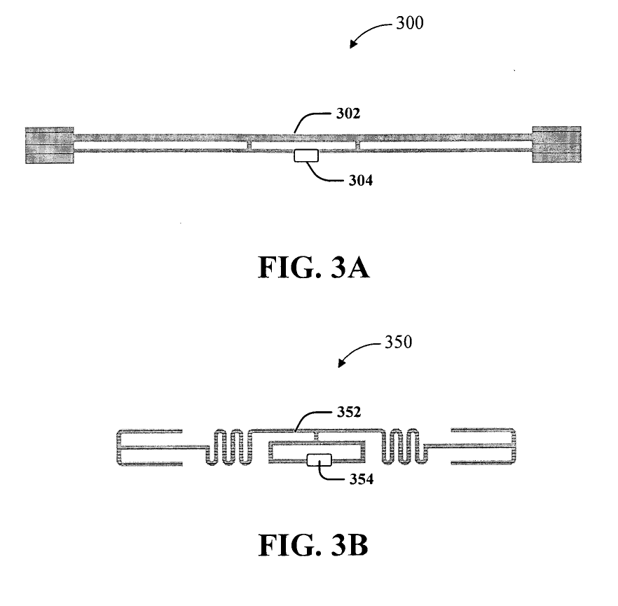

Advantageously, the gain of the RFID tag antenna is increased without directly connecting or modifying the existing RFID tag; the modifications include adding parasitic antenna elements to reconfigure the antenna of the RFID tag as a Yagi antenna. Many RFID tag antenna designs are usually based on variations of the basic folded dipole so that a differential input feed can be provided to the ASIC. The exact designs may include additional capacitive or inductive loading, matching shorts or even meandering structures, but most designs can be derived from a folded dipole approach. For example typical RFID tag designs are shown in FIGS. 3A-3B. The tag 300 in FIG. 3A has an I-type antenna 302 with a folded dipole structure with capacitive loading at the ends, to reduce the length, and inductive stubs to perform matching between the antenna and the ASIC 304. Another example RFID tag 350 is shown in FIG. 3B and the antenna 352 has a basic folded dipole structure with meandering element (hereinafter referred to as a squiggle antenna) and an ASIC 354.

The gain can be increased significantly by adding parasitic elements and forming a Yagi antenna. A Yagi antenna comprises an array of a dipole antenna and one or more parasitic elements. A Yagi antenna increases directionality versus a bare dipole antenna. The parasitic elements can include a single reflector and one or more directors. However, other combinations of parasitic elements are possible, such as one reflector and no directors or one or more directors and no reflectors. According to one embodiment, the reflector can be positioned behind the driven element (RFID tag) and can be slightly longer than one half (½) the tag's operating wavelength; one or more directors are placed in front of the driven element and are slightly shorter than ½ wavelength. Gains of over 10 dBi can be achieved for the parasitically modified RFID antennas compared to the unmodified RFID antenna.

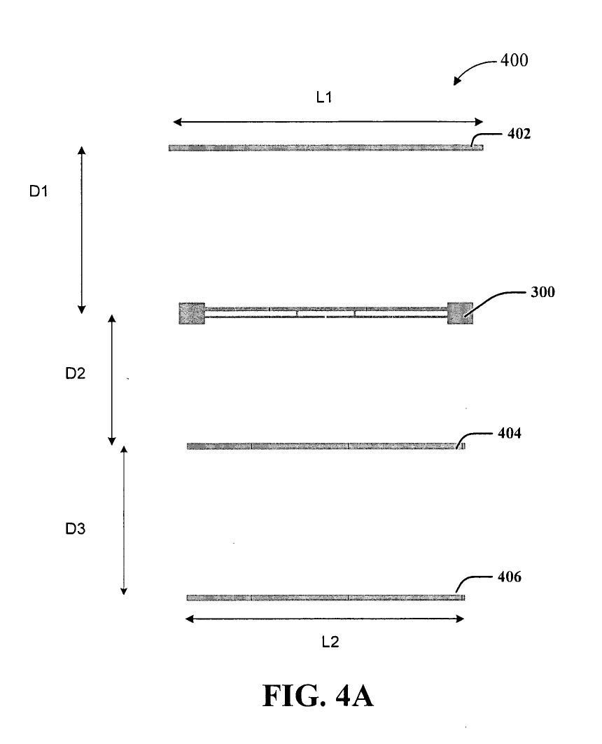

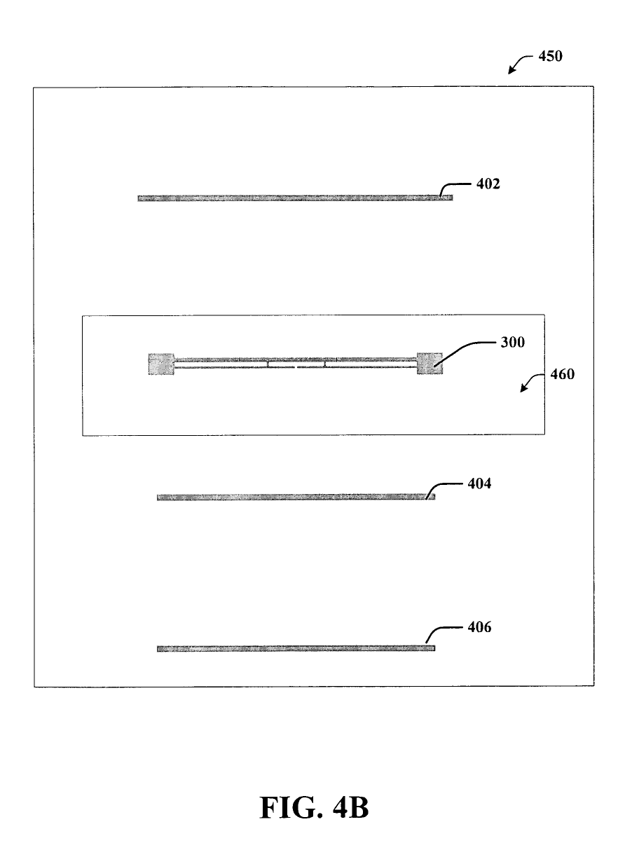

Referring to FIG. 4A, a commercially available “I” type RFID tag (300) is used to illustrate the parasitically modified RFID antenna 400 according to one embodiment. The original commercially-available RFID tag 300 is used as the driven element, one reflector 402 and two directors (404, 406) are added essentially parallel to the longitudinal axis of the antenna of the driven element. The modification is performed without directly connecting or modifying the existing RFID tag and thus advantageously can be modified post-tag manufacture for a customized RFID application. In this example, the signal (not shown) to read the RFID would be coming from the bottom of the figure. Additional parasitic elements can also be added as needed in other embodiments.

Various dimensions can be used for the length of the reflector 402 and the directors (404, 406). In this example, the dimension for the distance between the longitudinal axis of the tag antenna and the reflector (D1) is 70 millimeters, the distance between the longitudinal axis of the tag antenna and director 404 (D2) is 55 millimeters, and the distance between director 404 and director 406 (D3) is 70 millimeters. However, the reflector 402 and the directors (403, 404) can be positioned at various distances as experimentally determined for the RFID tag's intended environment and operating wavelength. For example, in one embodiment the reflector 402 can be positioned between about 50 millimeters and about 100 millimeters from the longitudinal antenna axis and a director can be positioned between about 40 millimeters and about 100 millimeters from the longitudinal antenna axis. In this example, the length of the reflector 402 (L1) is 158 millimeters and the length of the directors (404, 406) (L2) is 140 millimeters for an operating wavelength of 915 MHz. However, one will appreciate that different lengths can be used for different operating wavelengths, such as those in the 2.4 GHz Industrial, Scientific and Medical (ISM) bands. As mentioned above, such dimensions as given in connection with the embodiment of FIG. 4A are to be considered non-limiting in that such values depend on the wavelength of RFID radiation.

Referring to FIG. 4B one way of adding the parasitic elements at the determined distances to a commercially-available RFID tag that lacks a Yagi design is illustrated. One will appreciate, however, that the parasitic elements can be added in other manners at the determined distances, such as each element added individually. One will also appreciate that RFID tag can be manufactured with the parasitic elements present at the appropriate distances. According to the illustration, some or all of the parasitic elements (402, 404, 406) are attached to a backing material 450, such as a flexible backing material. This backing material can be attached to the surface of the object to be tagged. Then, an RFID tag with its backing material 460 can be placed on top of the backing material 450 with the parasitic elements. Alternatively, some or all of the parasitic elements can be placed on a backing material and placed over the already attached RFID tag. The backing material can advantageously comprise a hole that helps orient the placement of the parasitic elements on the backing material around an existing RFID tag and its associated backing material.

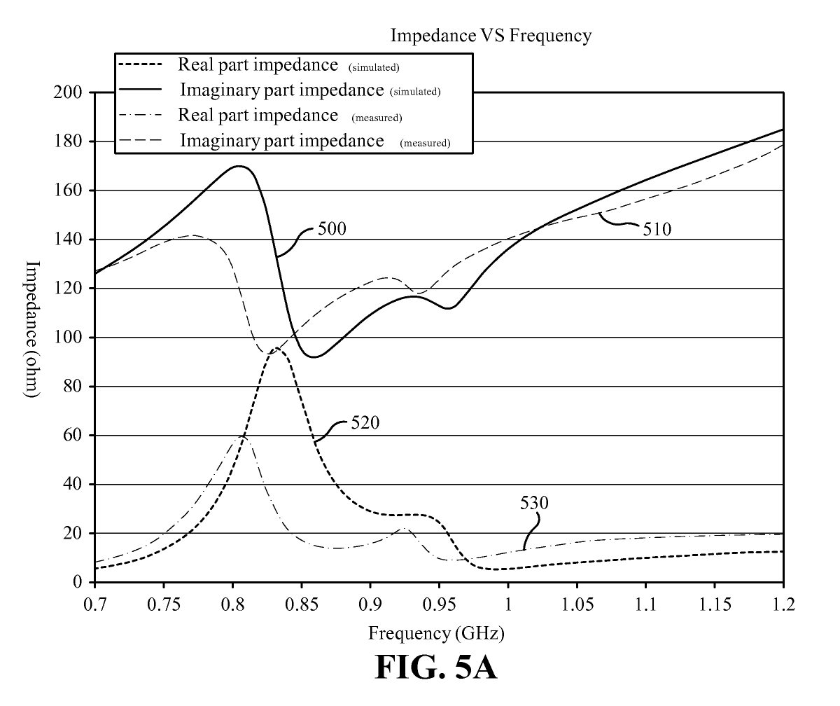

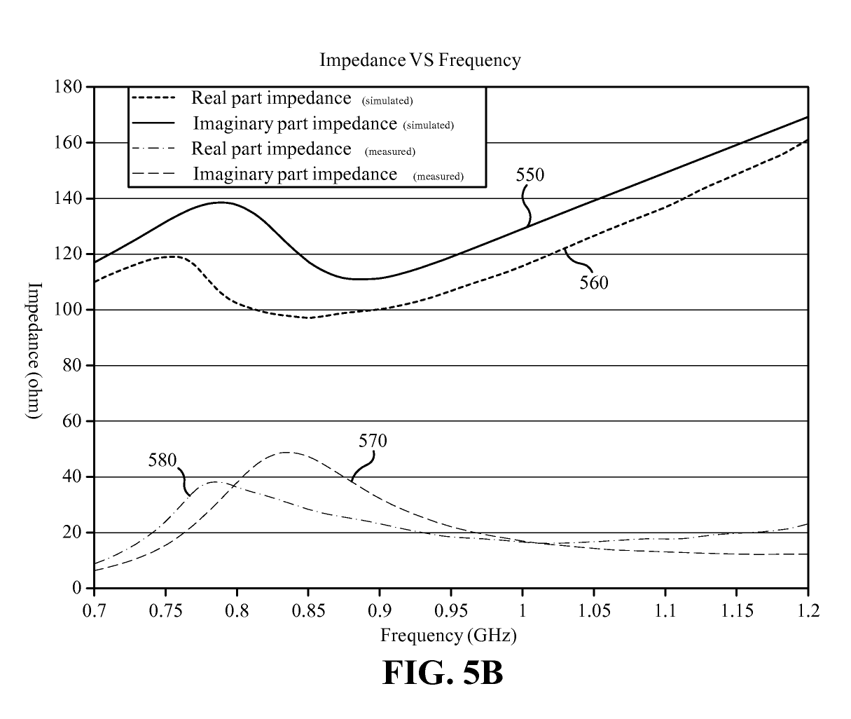

The design has been investigated by simulation and experiment with fully functional RFID tags. The simulated (500, 520) and measured (510, 530) impedance curves for the antenna geometry in FIG. 4A are shown in FIG. 5A. Impendance curves are shown for the real part (520, 530) and imaginary part (500, 510) of impendance. The impedance of the commercially-available antenna is distorted after introducing a reflector and one or more directors when compared to the antenna without the parasitic elements as shown in FIG. 5B. In particular, the simulated (550, 570) and measured (560, 580) impendance curves are shown in FIG. 5B with both imaginary (550, 560) and real part curves (570, 580). As can be observed both the real and imaginary impedance has changed by 5 ohms.

The antenna should be conjugate matched with an ASIC chip for the operating wavelength. In this example, the 915 MHz ISM band is used and the conjugate match is around Z_{S}=30+110 j ohms, in order to provide maximum power transfer. Assuming the chip impedance to be constant across the band we can calculate the power reflection coefficient |S|² using

$${\vert S \vert}^{2} = {\vert \frac{{Z}_{L} - {Z}_{S}}{{Z}_{L} + {Z}_{S}} \vert}^{2} , 0 \leq {\vert S \vert}^{2} \leq 1 \qquad ( Eqn . 1 )$$

where Z_{L} is the antenna impedance and Z_{S} is the chip impedance. The bandwidth for a −10 dB return loss can be calculated.

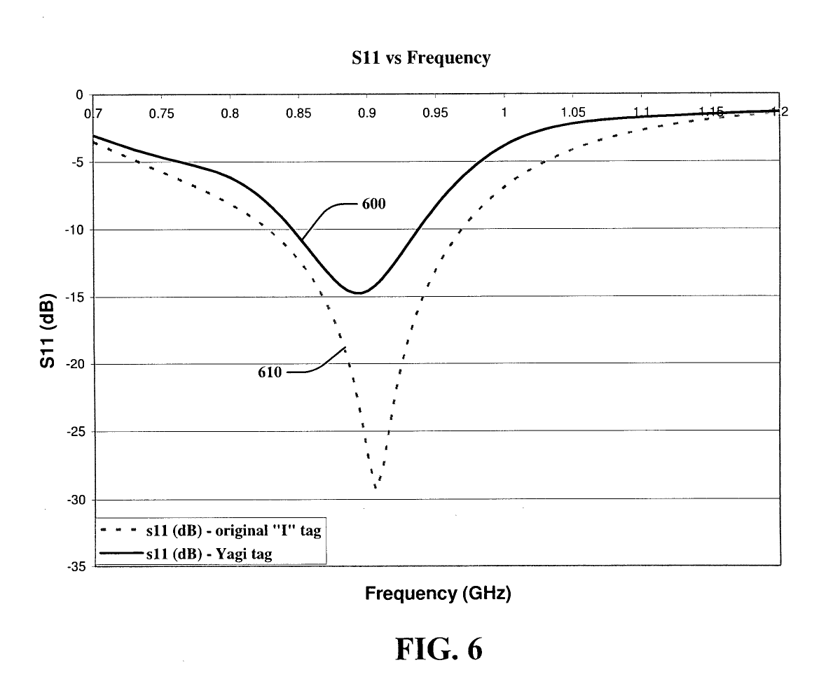

For the conventional tag, the S₁₁ curve 610 is shown in FIG. 6. The bandwidth at 850 MHz to 950 MHz for S₁₁ less than −10 dB. The simulated antenna gain is 2.3 dBi.

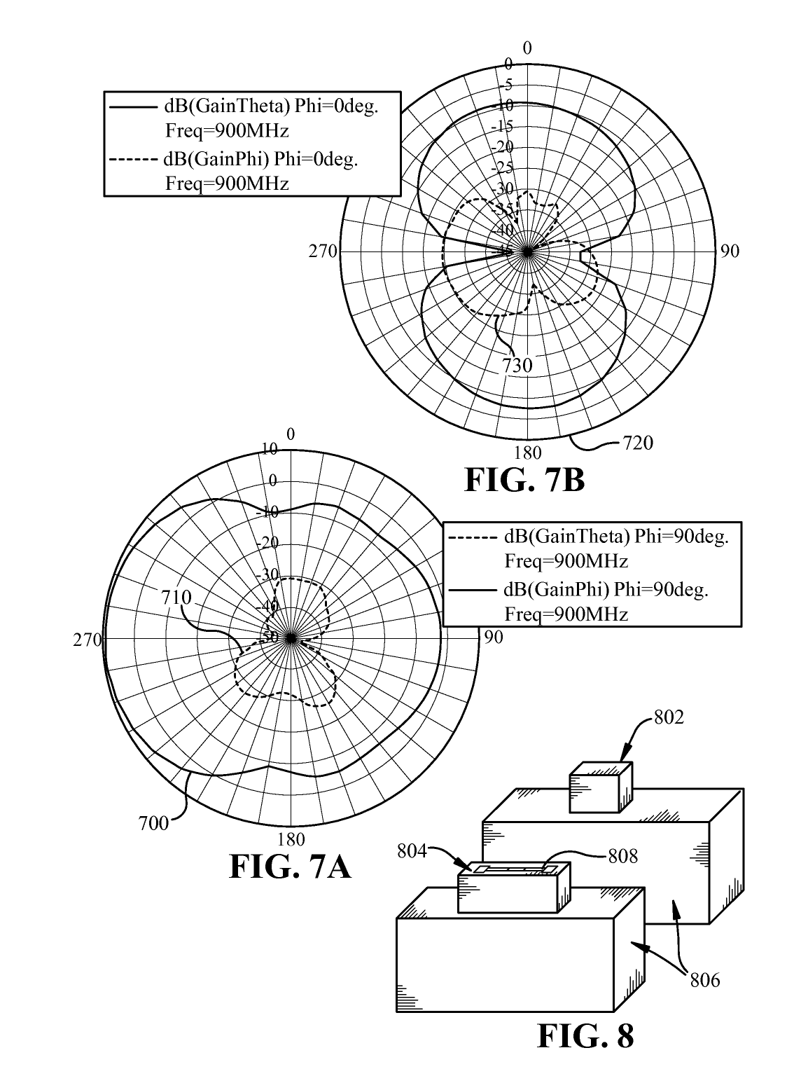

In one embodiment, the tag design with added parasitic elements is optimized not only for maximum gain but also maximum bandwidth. The calculated bandwidth curve 600 according to one embodiment for the tag design with parasitic elements (Yagi tag) is shown in FIG. 6. Maximum simulated gain is 8.9 dBi and the simulated patterns are shown in FIGS. 7A-7B. FIG. 7A illustrates the simulated pattern in a space with a Phi of 90 degrees at 900 MHz for the unmodified antenna 710 and the modified antenna 700. FIG. 7B illustrates the simulated pattern in a space with a Phi of 0 degrees at 900 MHz for the unmodified antenna 730 and the modified antenna 720. The gain is increased by over 6 dB compared to the unmodified design.

In order to experimentally demonstrate the effectiveness of the approach, parasitic elements were added to a commercially-available tag and the reading range compared with and without the Yagi elements. The setup is shown in FIG. 8. A commercially-available RFID reader 802, which operates at the correct frequency for the tag 808 (both unmodified and modified), was used to determine the reading range measurement with the reader antenna placed vertically on a table. The RFID tag 808 is then placed on a foam board 804 having dimensions of about ⅔ of a wavelength by ⅔ of a wavelength, which is adjusted on benches 806 so that the tag antenna is at the same level as the middle of reader antenna. In the special case of a 900 MHz wavelength, ⅔×⅔ of a wavelength corresponds to about 200 mm×200 mm. The orientation of the Yagi tag design with parasitic elements during the experiment was with the directionality of the Yagi antenna.

In order to determine the tag range performance, the tag read rate in reads per second is used. Depending on the distance from the reader the tag read rate can vary from 0 to 400 reads per second. In this measurement, a tag at a range with a read rate of 50 reads per second is regarded as a reliable reading range. With a reader EIRP of 0.5 watt, the reading range for an unmodified commercially-available “I” type tag and the Yagi modified version was 1.05 meter and 2.20 meter respectively. Thus, the maximum reading range is increased by more than double using the modifications on a commercially-available RFID tag.

Further examples are summarized in Table 1. For example, a cardboard box with dimensions of about ⅘ of a wavelength by ⅔ of a wavelength by 4/15 of a wavelength and various contents considered were loosely packed clothes, plastic scraps and metal scraps since reading performance varies when the tag is placed on or near different materials. In the special case of a 900 MHz frequency, such dimensions for the cardboard box are about 240 mm×200 mm×80 mm For example, when the tag is placed on a box with plastic, an over twenty percent (20%) reduction in reading range occurs as compared to an empty box. Such variations are expected as the dielectric and conductive properties of the background material will affect the antenna performance. In order to achieve a minimum reading distance, the distance and number of parasitic elements can be adjusted according to the materials present in the proximity of the RFID tag.

The same set of measurements was also performed by replacing the “I” type commercially-available antenna (similar to FIG. 3A) with the commercially-available squiggle tag antenna (similar to FIG. 3B). Even though the squiggle design is narrower than the original tag, the same dimensions and configuration for the parasitic elements as in FIG. 4A was utilized. The maximum reading range for the squiggle type tag and the Yagi RFID antenna was 0.92 meter and 1.7 meter respectively and the read range is increased.

TABLE 1
Reading range for various tags and their placement on various material
combinations when the frequency is 900 MHz

| | Foam | Empty box | Box with clothes | Box with plastic | Box with metal |
|---|---|---|---|---|---|
| “I” tag | 1.05 m | 1.05 m | 0.98 m | 0.92 m | 0.61 m |
| Yagi “I” tag | 2.20 m | 1.85 m | 1.70 m | 1.34 m | 1.08 m |
| Squiggle tag | 0.92 m | 0.82 m | 0.72 m | 0.7 m | 0.49 m |
| Yagi squiggle tag | 1.7 m | 1.61 m | 1.34 m | 1.25 m | 1 m |

For the avoidance of doubt, Table I applies to the special case when the frequency is 900 MHz, but should be considered non-limiting on the use of other frequencies. Two disadvantages of the Yagi antenna design are the larger size and the increased directionality. In order to overcome the directionality and avoid worrying about the orientation of the RFID tagged object, multiple RFID tags with a Yagi design can be used on a single tagged object. For example, two RFID tags with Yagi designs can be oriented perpendicular to each other. In other embodiments, two RFID tags with Yagi design can be oriented parallel to each other but have opposite directionality.

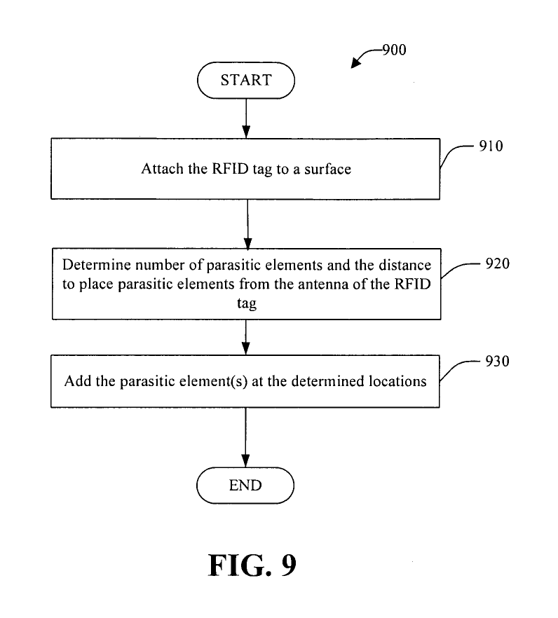

Turning briefly to FIG. 9, a methodology that may be implemented in accordance with the present invention is illustrated. While, for purposes of simplicity of explanation, the methodology is shown and described as a series of blocks, it is to be understood and appreciated that the present invention is not limited by the order of the blocks, as some blocks may, in accordance with the present invention, occur in different orders from that shown and described herein. Moreover, not all illustrated blocks may be required to implement the methodology in accordance with the present invention.

Referring to FIG. 9, an exemplary method 900 for increasing the reading distance of an RFID tag is illustrated. At 910, the RFID tag is attached to a surface, such as the surface of a tagged object or a flexible backing material of the RFID tag (e.g., the substrate the RFID tag). At 920, the number of parasitic elements is determined as well as the distance to place the parasitic elements from the antenna of the RFID tag. The distance can be dependent on the presence of high dielectric material in the reading environment (e.g., in the product packing) or the material the tagged object is made of (e.g., metal vs. plastic). At 930, the parasitic elements are added at the determined locations.

Although not shown, one will appreciate that multiple tags can be attached to the surface of a tagged object. One will also appreciate that act 920 may be performed once for a set of tags to be used in a similar reading environment and used at the same operating frequency and the distances used for each tag in the set. Similarly, the distances may be predetermined and act 920 not performed. For example, some or all of the parasitic elements themselves may be available on a flexible backing that allows easy addition of the parasitic elements without determination of the right distance to place the parasitic elements from the longitudinal axis of the antenna.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Moreover, one will appreciate that reference to various operating wavelengths is only exemplary and other bands can be used as allowed in compliance with local radio communication regulations.

What is claimed is:

1. A radio frequency identification (RFID) tagged object comprising:
an object;
a first RFID tag attached to the object, the first RFID tag having an antenna and an RFID application-specific integrated circuit (ASIC) communicatively coupled to the antenna, the RFID tag operates at an operating wavelength, the antenna having a longitudinal axis and; and
one or more parasitic elements associated with the first RFID tag, the one or more parasitic elements substantially parallel to the antenna axis of the first RFID tag.

2. The tagged object of claim 1 wherein the one or more parasitic elements includes a reflector.

3. The tagged object of claim 2 wherein the one or more parasitic elements includes one or more directors, the reflector on an opposite side of the antenna than the one or more directors.

4. The tagged object of claim 3 wherein the reflector is positioned between about one sixth of a wavelength associated with the operating frequency and about one third of the wavelength from the antenna axis and at least one director is positioned between about two fifteenths of the wavelength and one third of the wavelength from the antenna axis.

5. The tagged object of claim 3 wherein the reflector is slightly longer than half the operating wavelength and the one or more directors are slightly shorter than half the operating wavelength.

6. The tagged object of claim 1, further comprising:
a second RFID tag attached to the object, the second RFID tag having an antenna and an RFID application-specific integrated circuit (ASIC) communicatively coupled to the antenna, the antenna having a longitudinal axis; and
one or more parasitic elements associated with the second RFID tag, the one or more parasitic elements substantially parallel to the antenna axis of the second RFID tag and oriented for a different directionality than the one or more parasitic elements associated with the first RFID tag.

7. The tagged object of claim 6 wherein the antenna axis of the first tag is substantially perpendicular to the antenna axis of the second tag.

8. The tagged object of claim 1 wherein the first RFID tag is a passive RFID tag.

9. The tagged object of claim 1 wherein the particular wavelength is in the ultra high frequency (UHF) band.

10. A method of increasing the reading distance of a passive radio frequency identification (RFID) tag, the method comprising:
attaching a passive RFID tag to a surface, the RFID tag having an antenna, the antenna having a longitudinal axis; and
adding one or more parasitic elements in close proximity to the antenna, the one or more elements essentially parallel to the antenna axis of the RFID tag.

11. The method of claim 10 wherein the attaching of an RFID tag to a surface includes attaching the RFID tag to a surface of an object and wherein the adding of one or more parasitic elements in close proximity to the antenna includes attaching the parasitic elements to the surface of the object.

12. The method of claim 10 wherein the adding of one or more parasitic elements in close proximity to the antenna includes attaching the parasitic elements to a backing material of the RFID tag.

13. The method of claim 10 wherein the adding of the one or more parasitic elements in close proximity to the antenna includes attaching a reflector and one or more directors, the reflector is attached on an opposite side of the antenna axis from the one or more directors.

14. The method of claim 10 wherein the adding of one or more parasitic elements in close proximity to the antenna includes determining a distance to place each of the one or more parasitic elements from the antenna axis.

15. An radio frequency identification (RFID) system comprising:
a plurality of RFID tags having an operating wavelength, each RFID tag comprising:
an RFID antenna, the antenna having a longitudinal axis;
an application-specific integrated chip (ASIC), the ASIC operable to receive signals from the RFID antenna; and
one or more parasitic elements in close proximity to the antenna, the parasitic elements substantially parallel to the longitudinal antenna axis; and
an RFID tag reader operable to send and receive radio frequency energy substantially equivalent to the operating wavelength of the plurality of RFID tags.

16. The system of claim 15 wherein the one or more parasitic elements include a reflector and one or more directors.

17. The system of claim 16 wherein the reflector is slightly longer than one half the operating wavelength and at least one of the one or more directors is slightly less than one half the operating wavelength.

18. The system of claim 16 wherein the reflector is on an opposite side of the antenna axis from the one or more directors.

19. The system of claim 15 wherein the RFID antenna and the ASIC are a commercially-available RFID tag that does not comprise the one or more parasitic elements.

20. The system of claim 15 wherein the operating wavelength is in an industrial scientific and medical (ISM) band.
